(19) United States
(12) Patent Application Publication
(10) Pub. No.: US 2001/0046951 A1
(43) Pub. Date: Nov. 29, 2001

(54) Bleaching detergent composition

(75) Inventors: Nobuyuki Ogura, Wakayama (JP); Muneo Aoyagi, Wakayama (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kao Corporation, Tokyo (JP)

(21) Appl. No.: 09/770,287

(22) Filed: Jan. 29, 2001

(30) Foreign Application Priority Data
Feb. 2, 2000 (JP) 2000-25087
Jun. 1, 2000 (JP) 2000-164845

(51) Int. Cl. C11D 7/54; C11D 7/18; C11D 3/48; C11D 9/42

(52) U.S. Cl. 510/302; 510/312; 510/313; 510/314; 510/376; 510/384; 510/504

(57) ABSTRACT

The present invention provides a bleaching detergent composition exhibiting a wide bleaching effect for various stains including hydrophilic stains and olephilic stains, as well as an high bleaching effect and dye-transfer inhibiting effect in a wide range of temperature from a low to a high temperature of laundry water. That is, the present invention provides a bleaching detergent composition comprising (a) an alkannitrile compound having a quaternary ammonium group bondeded to a carbon atom to which the nitrile group is bonded, (b) an inorganic peroxide and (c) an alkali metal carbonate and further comprising component (d-i) an alkanoyloxybenzenesulfonic acid having an alkanoyl group of 6 to 14 carbon atoms or an alkanoyloxybenzenecarboxylic acid having an alkanoyl group of 6 to 14 carbon atoms or a salt thereof and/or (d-ii) tetraacetylethylenediamine.

### TECHNICAL FIELD OF INVENTION

The present invention relates to a bleaching detergent composition.

PRIOR ART AND PROBLEMS TO BE SOLVED BY INVENTION

Stains caused by food, yellowish change in color of underwear and the like are stains which cannot be got rid of by an ordinary detergent. Therefore, such techniques are employed that a bleaching agent is generally used together with a detergent or that a detergent in which a bleaching agent is blended is used. In addition, in order to enhance the bleaching effect of the bleaching agent, a bleaching activator is often used together with the detergent. JP-A 59-22999 discloses a detergent composition in which a sodium alkanoyloxybenzenesulfonate is used. Further, JP-A 1-68347 discloses that the present inventors have discovered that a bleaching activator containing a nitrile group is useful. By the way, when laundering is carried out, it is generally required that various stains including a hydrophilic stain caused by tea, wine or the like, an oily stain caused by a food, a oleophilic stain such as yellowish change in color of underwear caused by sweat, and the like can be widely bleached.

A bleaching activator which produces an organic peracid having a short chain alkyl group as the activating specie is normally effective for the hydrophilic stains. A bleaching activator which produces an organic peracid having an intermediate-length-chain or long chain alkyl group as the activating specie is normally effective for the oleophilic stains. Accordingly, in order to solve the problems described above, a method may be considered in which two bleaching activators having the different number of carbon atoms are used together. For example, there can be considered a method using a sodium alkanoyloxybenzenesufonate which reacts with hydrogen peroxide in water so as to produce an organic percarboxylic acid having 8 to 14 carbon atoms together with tetraacetylethylenediamine (TAED) which produces a peracetic acid. However, by such a combination, the amount of the bleaching activator as a whole to be blended must be increased in order to obtain a sufficient effect.

Further, in addition to the above-mentioned problems, there is another problem called as “dye-transfer” in which dyes of some colored or designed clothes come off to adhere other clothes during laundering. It is known that, when the temperature of laundering water is higher, the dye-transfer occurs with a significant probability. As a method of solving this problem, JP-A 7-501092 discloses a composition comprising a specific enzyme and hydrogen peroxide. However, this composition neither has a satisfactory effect for inhibiting dye-transfer in washing at a high temperature nor obtains a satisfactory bleaching effect in spite of the presence of hydrogen peroxide.

Accordingly, an object of the present invention is to provide a bleaching detergent composition which is widely effective to various stains and which occurs less dye-transfer.

### DISCLOSURE OF THE INVENTION

The present invention provides a bleaching detergent composition comprising (a) an alkannitrile derivative in which a quaternary ammonium group is bonded to the α-carbon atom of the derivative, (b) an inorganic peroxide, and (c) an alkali metal carbonate. The present invention further provides a bleaching detergent which is effective to all of variable stains by using an alkannitrile derivative in which a quaternary ammonium group is bonded to the α-carbon atom of the derivative together with an alkanoyloxybenzenesulfonic acid having the alkanoyl group of 6 to 14 carbon atoms or an alkanoyloxybenzenecarboxylic acid having the alkanoyl group of 6 to 14 carbon atoms or a salt thereof (referred to as the component (d-i), hereinafter). The other mode of the present invention provides a bleaching detergent in which dye-transfer occurring at a high temperature in the laundering liquid can be inhibited by using an alkannitrile derivative in which a quaternary ammonium group is bonded to the α-carbon atom of the derivative together with tetraacetylethylenediamine (referred to as the component (d-ii), hereinafter) to be capable of obtaining an excellent bleaching effect in a wide temperature-range. It should be noted that the α-position of the component (a) is a position in which the nitrile group is a functional group thereof.

The present invention provides a bleaching detergent composition comprising (a) an alkannitrile derivative in which a quaternary ammonium group is bonded to the α-carbon atom of the derivative, (b) an inorganic peroxide, and (c) an alkali metal carbonate; which further comprises an alkanoyloxybenzenesulfonic acid having an alkanoyl group of 6 to 14 carbon atoms or an alkanoyloxybenzenecarboxylic acid having an alkanoyl group of 6 to 14 carbon atoms or a salt thereof or which further comprises tetraacetylethylenediamine.

### MODES FOR CARRYING OUT THE INVENTION

The Component (a)

As the component (a) of the present invention, a compound represented by the following formula (1) or (2) is particularly preferable.

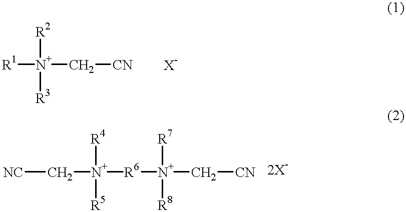

wherein R¹ represents an alkyl group having 1 to 6, preferably 1 to 4 and particularly preferably 1 to 3 carbon atoms, which may be interrupted by an ester group, an amide group or an ether group; R⁶ represents an alkylene group having 1 to 8 and preferably 2 to 6 carbon atoms, which may be interrupted by an ester group, an amide group or an ether group and which may be substituted by a hydroxy group; each of R², R³, R⁴, R⁵, R⁷ and R⁸ independently represents an alkyl or hydroxyalkyl group, and preferably methyl group, ethyl group or hydroxyethyl group, having 1 to 3 carbon atoms; and X⁻ represents an anionic ion, and preferably a halogen ion, sulfate ion, a fatty acid ion or an alkyl sulfate ion having 1 to 3 carbon atoms.

As shown in the formula below, the component (a) reacts with a hydroperanion produced from an inorganic peroxide compound described below in a laundering solution, thereby exhibiting a high bleaching effect because of generating peroxyimidic acid.

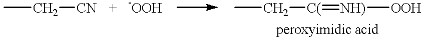

The amount of the component (a) to be blended is preferably 0.05 to 20% by weight, more preferably 0.1 to 15% by weight and most preferably 0.1 to 10% by weight in the bleaching detergent composition.

The Component (b)

The inorganic peroxide compound as the component (b) of the present invention is preferably a percarbonate or a perborate. When the component (b) is used for a detergent containing zeolite, it is preferable to use coated sodium percarbonate as the component (b). The coated sodium percarbonate can be produced by a publicly known method. For example, the method may be disclosed in JP-A 59-196399 (in which sodium percarbonate is coated with a borate). The amount of the component (b) to be blended is preferably 0.5 to 99% by weight, more preferably 1 to 95% by weight and most preferably 1 to 90% by weight in the bleaching detergent composition.

The Component (c)

The alkali metal carbonate as the component (c) of the present invention is preferably a sodium salt in view of excellent stability. Examples of the sodium salt include sodium carbonate, sodium bicarbonate and sodium sesquicarbonate. Sodium carbonate is most preferable. The component (c) may be specially dry-blended together with granules of the bleaching activator and the inorganic peroxide compound. In this case, one having the average granular diameter of 100 to 500 μm is preferably used. Further, for the blending, it may be formed a slurry or kneading-intimate mixture having its high density with a surfactant, zeolite and the other detergent aid in order to obtain granules of a detergent base material by drying the slurry or mixture. The amount of the component (c) to be blended is preferably 0.5 to 60% by weight and more preferably 1 to 50% by weight in the bleaching detergent composition.

The Component (d-i)

In the present invention, by using the component (d-i) which is an alkanoyloxybenzenesulfonic acid having an alkanoyl group of 6 to 14 and preferably 7 to 13 carbon atoms or an alkanoyloxybenzenecarboxylic acid having an alkanoyl group of 6 to 14 and preferably 7 to 13 carbon atoms or a salt thereof together with the bleaching activator of the component (a), a bleaching effect can be widely obtained for various stains including hydrophilic stains and oleophilic stains. Specific examples thereof include octanoyloxy-p-benzenesulfonic acid, nonanoyloxy-p-benzenesulfonic acid, 3,5,5-trimethylhexanoyloxy-p-benzenesulfonic acid, decanoyloxy-p-benzenesulfonic acid, dodecanoyloxy-p-benzenesulfonic acid, octanoyloxy-o-benzenecarboxylic acid, octanoyloxy-p-benzenecarboxylic acid, nonanoyloxy-o-benzenecarboxylic acid, nonanoyloxy-p-benzenecarboxylic acid, 3,5,5-trimethylhexanoyloxy-o-benzenecarboxylic acid, 3,5,5-trimethylhexanoyloxy-p-benzenecarboxylic acid, decanoyloxy-o-benzenecarboxylic acid, decanoyloxy-p-benzenecarboxylic acid, dodecanoyloxy-o-benzenecarboxylic acid, dodecanoyloxy-p-benzenecarboxylic acid, and a salt thereof. The salt is preferably sodium salt, potassium salt or magnesium salt, and particularly preferably sodium salt in view of solubility.

Among them, nonanoyloxy-p-benzenesulfonic acid, decanoyloxy-p-benzenesulfonic acid, dodecanoyloxy-p-benzenesulfonic acid and a salt thereof are particularly preferable in view of bleaching effect for oleophilic stains. The amount of the component (d-i) to be blended is preferably 0.05 to 20% by weight, more preferably 0.1 to 15% by weight and most preferably 0.2 to 10% by weight in the bleaching detergent composition.

When the component (d-i) is used together, the total amount of the component (a) and the component (d-i) is preferably 0.1 to 40% by weight, more preferably 0.2 to 30% by weight and most preferably 0.2 to 15% by weight in the composition. Further, the molar ratio of (a)/(d-i) is preferably 1/10 to 10/1, more preferably 1/5 to 5/1 and most preferably 1/1 to 5/1 in order obtain an excellent bleaching effect for both hydrophilic and oleophilic stains.

The Component (d-ii)

In the bleaching detergent composition of the present invention, a bleaching detergent which occurs no dye-transfer and which has an excellent bleaching effect in a wide temperature-range of from a low temperature to a high temperature can be obtained by blending tetraacetylethylenediamine as the component (d-ii) together with the bleaching activator of the component (a). Such a bleaching effect is significantly observed in a laundering method comprising washing clothes after soaking in hot water for a while or another laundering method comprising heating, which is traditional in Europe. The amount of the component (d-ii) to be blended is preferably 0.05 to 20% by weight, more preferably 0.1 to 15% by weight and most preferably 0.1 to 10% by weight in the bleaching detergent composition.

When the component (d-ii) is used together, the ratio of the component (a) to the component (d-ii), namely (a)/(d-ii), by weight is preferably 1/10 to 10/1, more preferably 1/5 to 5/1 and most preferably 1/3 to 3/1.

The composition of the present invention has preferably a powdery form. The component (a), the component (b), the component (c), the component (d-i) and the component (d-ii) are adjusted so as to have a powdery or granular form. It is particularly preferable that the component (a), the component (d-i) and the component (d-ii) are blended to the composition as granulated matters. The component (a), the component (d-i) and/or the component (d-ii) may be separately blended as granulated matters. Alternatively, the component (a) and at least one of the component (d-i) and the component (d-ii) may be blended as altogether-granulated matters for use. The amount of the component (a) and/or the component (d-i) to be blended is preferably 1 to 90% by weight, more preferably 10 to 85% by weight and most preferably 30 to 80% by weight in the granulated matters. On the other hand, the amount of the component (a) and/or the component (d-ii) to be blended is preferably 1 to 95% by weight, more preferably 10 to 90% by weight and most preferably 30 to 85% by weight in the granulated matters. These are made to be preparations by using a binder material selected from polyoxyethylene and a fatty acid. It is good that the average molecular weight of the polyoxyethylene is preferably 2000 to 20000, more preferably 4000 to 10000 and most preferably 4000 to 8000. The fatty acid has preferably 8 to 20 carbon atoms, more preferably 10 to 18 carbon atoms and most preferably 12 to 18 carbon atoms. The fatty acid may be in a state of sodium or potassium soap. The amount of the binder material as described above to be used is 0.5 to 30% by weight, preferably 1 to 20% by weight and more preferably 5 to 20% by weight in the granulated matters.

In addition, in order to improve the solubility of the bleaching activator in the laundering solution, a polyoxyalkylenealkyl ether, an alkylsulfate salt or a polyoxyethylenealkyl ether sulfate salt or a mixture thereof is blended in an amount of preferably 0 to 50% by weight, more preferably 5 to 45% by weight and most preferably 10 to 40% by weight in the granulated matters. The polyoxyalkylenealkyl ether preferably has its alkyl group of 10 to 14 carbon atoms and is preferably an adduct with ethylene oxide (referred to as EO, hereinafter) and/or propylene oxide (referred to as PO, hereinafter) and more preferably a block adduct of EO and PO. The any average number of moles to be added of only EO, only PO and a mixed one of EO and PO is preferably 1 to 30 and more preferably 1 to 15 in total. The molar ratio of EO/PO is preferably 5/1 to 1/5 and more preferably 3/1 to 1/2. The alkylsulfate salt has its alkyl group of 10 to 18 carbon atoms and is preferably an alkali metal salt such as sodium salt and particular preferably sodium laurylsulfate or sodium myristylsulfate. The alkyl group of the polyoxyethylenealkyl ether sulfate salt has preferably 10 to 18 carbon atoms. It is good that the polyoxyethylenealkyl ether sulfate salt is a sodium salt. Here, it is good that the average degree of polymerization of oxyethylene groups (hereinafter, the average degree of polymerization will be referred to as POE) is 1 to 10 and preferably 1 to 5. Sodium polyoxyethylenelauryl ether sulfate (POE=2 to 5) or sodium polyoxyethylenemyristyl ether sulfate (POE=2 to 5), in particular, is good.

In the present invention, the above-mentioned compositions may be mixed and granulated by an optional method. By adding the binder material being melted in advance, desirable results can be obtained. The binder material is melted at 40 to 100° C., preferably at 50 to 100° C. and more preferably at 50 to 90° C., and then added. These are mixed by stirring until the mixture becomes homogeneous, then being made to be the preparations by using a standard granulating device. Examples of the preferable granulating method include a granulation by extrusion. It is preferable that the granulated matter is made to have its average granular diameter of 500 to 5000 μm and preferably 500 to 3000 μm. Then, the other example of a preferable granulation method can also include a method for granulating into a tablet form with a briquetting machine.

Further, in the present invention, an acidic material may be blended as necessary into the granulated matters so that the stability of the bleaching activator is improved. The acidic material is preferably an organic carboxylic acid. At least one acid selected from succinic acid, maleic acid, fumaric acid, citric acid, glycolic acid and p-hydroxybenzoic acid is particularly preferable. It is suitable that the amount of the acidic material as described above is preferably added in an amount of 0.5 to 20% by weight, more preferably 1 to 15% by weight and most preferably 1 to 10% by weight in the granulated matters.

It is preferable to use in a surfactant the bleaching detergent composition of the present invention for the purpose of improving the bleaching detergent effect. Specific examples of the surfactant include at least one anionic surfactant selected from an alkylbenzenesulfonate having the alkyl group of 10 to 20 and preferably 10 to 15 carbon atoms, an alkylsulfate salt having the alkyl group of 8 to 18 and preferably 10 to 14 carbon atoms, and a polyoxyethylenealkyl ether sulfate salt having the alkyl group of 8 to 18 and preferably 10 to 14 carbon atoms. The average number of moles of added EO to the polyoxyethylenealkyl ether sulfate salt is preferably 1 to 20, more preferably 1 to 10 and most preferably 1 to 5. The counter ion of the anionic surfactant described above is preferably an alkali metal such as sodium and potassium. It should be noted that an anionic surfactant other than the above-mentioned ones, a nonionic surfactant, a cationic surfactant or an amphoteric surfactant may be blended. Specific examples of such surfactants include an anionic surfactant such as an olefinsulfonate, an alkanesulfonate, a fatty acid salt, an alkyl or alkenyl ether carboxylate, a salt of α-sulfofatty acid and an ester of α-sulfofatty acid; a nonionic surfactant such as polyoxyethylene or polyoxypropylene or a copolymer thereof, a polyoxyethylene alkyl or alkenyl ether, polyoxyethylenealkylphenyl ether, an alkanol amide of a higher fatty acid or an adduct with an alkyleneoxide thereto, a sucrose fatty acid ester and an alkylglycoside; an amphoteric surfactant such as amine oxide, a sulfobetaine and a carbobetaine; and a cationic surfactant such as a quaternary ammonium salt. It is particularly preferable to blend a polyoxyethylene alkyl or alkenyl ether having the alkyl or alkenyl group of 10 to 20 and preferably 10 to 18 carbon atoms and a polyoxyethylene chain having its average condensation of 4 to 20 and preferably 4 to 15 in a molecule thereof or to blend a fatty acid soap having 8 to 18 and preferably 10 to 18 carbon atoms or an alkyl group-composition derived from palm oil or beef tallow. In the present invention, the amount of the surfactant to be blended is preferably 0.1 to 60% by weight, more preferably 0.1 to 50% by weight and most preferably 0.5 to 40% by weight in the bleaching detergent composition in view of the bleaching detergency and foaming property.

It is preferable that a silicate is blended in the bleaching detergent composition of the present invention. The silicate is preferably an amorphous sodium silicate such as Nos. 1-3 sodium silicate, a crystalline silicate disclosed in JP-A 7-89712, JP-A 60-227895 and Phys. Chem. Glasses. 7, p127-p138 (1966), Z. Kristallogr., 129, p396-p404 (1969), or a commercially-available crystalline sodium silicate as the trade name of “Na-SKS-6” (δ-Na₂Si₂O₅) supplied by Clariant.

The silicate in the present invention has the maximum pH of no lower than 11 when is dispersed into deionized water in a concentration of 0.1% by weight at 20° C. and is excellent in alkalinity (or basicity) requiring 5 ml or more of 0.1N HCl aqueous solution for lowering the pH of 1 L of the resultant dispersion liquid to 10. Accordingly, the silicate is distinguished from zeolite being a crystalline aluminosilicate.

The amorphous silicate is blended into the bleaching detergent composition by blending the silicate into the detergent base material together with the above-mentioned surfactant, the alkali metal carbonate and the other detergent aid, or by separately granulating the silicate and dry-blending the granules thereof to the composition. When the silicate is preferably blended into the detergent base material, the amorphous silicate acts as a skeleton forming agent for reinforcing the granules. The crystalline silicate is preferably dry-blended into the bleaching detergent composition, so as not to harm the ion-exchange capacity. The amount of the silicate to be blended is preferably 0.1 to 20% by weight, more preferably 0.5 to 10% by weight of the bleaching detergent composition.

In the present invention, it is preferable to blend a polymer component in order to improve the bleaching detergent property. Examples of the polymer component include a homopolymer such as polyacrylic acid, polymethacrylic acid, and polyhydroxyacrylic acid, and a carboxylic acid-based polymer such as copolymer of acrylic acid and maleic acid, besides a nonionic polymer such as polyethylene glycol. Among these examples, there are particularly preferable polyacrylic acid or polyhydroxyacrylic acid having the molecular weight of 5000 to 20000 or a salt thereof, copolymer of acrylic acid/maleic acid (at the molar ratio of 2/8 to 8/2) having the molecular weight of 30000 to 80000, and polyethylene glycol having the molecular weight of 4000 to 10000. The amount to be blended is preferably 0.05 to 20% by weigh and more preferably 0.1 to 10% by weight.

In the present invention, it is preferable to blend an enzyme such as cellulase, protease and lipase. In particular, use of an alkaline cellulase produced by an alkalophilic microorganism Bacillus SP KSM-635 (FERM BP-1485, deposited in Fermentation Research Institute as the international depositary authority, now reorganized to National Institute of Bioscience and Human-Technology, Agency of Industrial Science and Technology, 1-3, Higashi 1 chome Tsukuba-shi Ibaraki-ken 305, Japan) or a mutant thereof is preferable for the purpose of further improving the bleaching detergent effect. For the alkaline cellulose, the optimum pH is 7 or more when a carboxy methyl cellulose is a substrate or the relative activity at pH 8 or higher is no lower than 50% with respect to that observed in the optimum condition. A specific example of the commercially available granulated enzymes may be KAC 500 (supplied by Kao Corp.).

In addition, in the present invention, it is preferable to blend an alkaline protease. As such a protease, there is good an alkaline protease produced from Bacillus SP KSM-K16 (No. 11418 deposited in the same as above) and Bacillus SP KSM-K14 (No. 12587 deposited in the same as above). The commercially-available protease may be Alcalase® and Savinase® (supplied by Novo Nordisk A/C), Maxapem® (supplied by Genencor International), KAP 4.3 G and KAP 11.1 G (supplied by Kao Corp.).

Into the bleaching detergent composition of the present invention, there may be blended a metal ion exchanger zeolite A or P having its average granular diameter of 0.1 to 10 μm, which lowers a concentration of calcium, magnesium or the like in tap water or which improves the physical property as powder of the granules; a metal ion captor such as ethylenediaminetetraacetate, ethane-1,1-diphosphonic acid and ethane-1,1,2-triphosphonic acid, which suppress the decomposition of the blending species by heavy metals; a defoaming agent having silicone oil and silica carried on polyethylene glycol or a cellulose-based compound; Glauber's salt (sodium sulfate) as an extender (or weighting agent) of the detergent base material; the other fluorescent dye; a perfume; etc.

In the present invention, there can be used the above-mentioned optional component of the detergent having a powdery or briquette-formed composition. The producing method thereof is not particularly limited and a conventionally and publicly known method can be used thereas. It is preferably a granular composition having a high bulk-density. The method of making it have the high bulk-density includes a method of heightening the density by spraying a nonionic surfactant on the spray-dried granules and a method of heightening the density by making the powdery components containing an oil-absorbing carrier absorb and store a nonionic surfactant directly, for instance. There may be referred to the methods disclosed in JP-A 61-69897, JP-A 61-69899, JP-A 61-69900, JP-A 2-222498, JP-A 2-222499, JP-A 3-33199, JP-A 5-86400 and JP-A 5-209200. Further, zeolite may be added in a small amount for using as a surface modifier of the granules during the granulation or immediately before the completion of the granulation. When the crystalline silicate is blended, the crystalline silicate is preferably added during the making it have bulk-density or added by dry-blending. When the alkali metal carbonate is blended, the alkali metal carbonate may be blended into the slurry, blended during the granulation or blended by dry-blending.

The average granular diameter of the bleaching detergent composition in the present invention is desirably 200 to 1000 μm and particularly desirably 200 to 600 μm for obtaining a preferable physical property as powder. In addition, the bulk-density of the bleaching detergent composition in the present invention is 0.5 to 1.2 g/cm³ and preferably 0.6 to 1.0 g/cm³.

The bleaching detergent composition of the present invention may be used at a suitable concentration for each of washings such as a washing by a laundry machine and a washing depending on a washing method by soaking for a while and depending an amount of clothes or water, a stained degree and a method of using the machine or the like. In the case of washing by a laundry machine, for example, the concentration thereof for use is preferably 0.03 to 0.3% by weight. In the case of washing after soaking for a while, the concentration thereof for use is preferably 0.1 to 2% by weight.

### EXAMPLES

### Preparation of the Bleaching Activator

### Synthesis Example 1

### Synthesis of Compound A-1

An ordinary quaternization reaction was carried out by using chloroacetonitrile and trimethylamine, thereby synthesizing the compound A-1 shown below. Acetone was used as the solvent. It is used a following process that trimethylamine was introduced into the reactor in a gaseous state. The reaction temperature was 60° C. The crystals deposited after the reaction were filtered with blowing nitrogen gas thereto and the obtained crystals were washed with acetone several times and dried. The crystals were moisture-absorbing materials and then the crystals were stored in a desiccator.

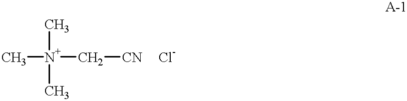

### Synthesis Example 2

### Synthesis of Compound A-2

An ordinary quaternization reaction was carried by using chloroacetonitrile and tetramethylethylenediamine, thereby synthesizing the compound A-2 shown below. Acetone was used as the solvent. The reaction temperature was 60° C. and the reaction was carried out for approximately 5 hours. After the reaction completed, the deposited crystals were filtered. The obtained crystals were filtered with acetone several times and then dried.

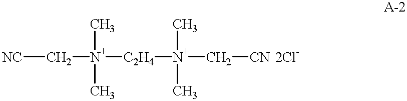

### Granulation of the Bleaching Activator

### Production Example 1

The granulated matters shown in Table 1 were prepared with by the following compounds and by method.

AS: Sodium laurylsulfate

ES: Sodium polyoxyethylenelauryl ether sulfate (The average number of moles of added EO is 3.)

POEO: Block adduct with 2 moles of EO on the average, 3 moles of PO on the average and 3 moles of EO on the average in order to lauryl alcohol.

PEG: Polyoxyethylene (with the molecular weight of 8000, supplied by Aldrich)

FA: Myristic Acid

Succinic Acid

Production example 1-1 (Production of granulated matter a-1)

70 parts by weight of the compound A-1, 20 parts by weight of PEG, 5 parts by weight of FA and 5 parts by weight of AS were charged in a high-speed mixer (FS-GC-10) supplied by Fukae Kogyo K. K., so that a total sum of them was 5000 g (using PEG and FA melted in advance at 80° C.). They were mixed and heated with a jacket having its temperature at 80° C., a main shaft having its rotation rate at 200 rpm and a pulverizing vane having its rotation rate at 1500 rpm. When the temperature of the powder reached to 70° C., the obtained mixture was taken out and then extruded through a screen having its pore diameter of 800 μm by Mill with extruding (supplied by Fuji Powder, Pelletter Double EDX-100). The obtained extruded-material was cooled by a cooling device with vibration (supplied by Fuji Powder, Vibro/Flow Drier VDF/6000) and then pulverized by a Mill (supplied by Fuji Powder, Flash Mill FL-200). The obtained pulverized material was classified, thereby obtaining the granulated matter a-1 having its average granular diameter of 900 μm.

### Production Example 1-2

### Production of Granulated Matter a-2

The granulated matter a-2 was produced in the same manner as in Production example 1-1 except that the compound A-1 was replaced with the compound A-2.

### Production Example 1-3

### Production of Granulated Matter d-i-1

The granulated matter d-i-1 was produced in the same manner as in Production example 1-1 except that the raw (or starting) materials charged in the high-speed mixer were replaced with 70 parts by weight of sodium dodecanoyloxybenzenesulfonate, 5 parts by weight of POEO, 5 parts by weight of ES, 5 parts by weight of succinic acid and 15 parts by weight of PEG.

### Production Example 1-4

### Production of Granulated Matter ab-1

The granulated matter ab-1 was produced in the same manner as in Production example 1-1 except that the raw materials charged in the high-speed mixer were replaced with 35 parts by weight of the compound A-1, 35 parts by weight of sodium nonanoyloxy-p-benzenesulfonate, 5 parts by weight of POEO, 5 parts by weight of ES, 5 parts by weight of succinic acid and 15 parts by weight of PEG.

### Production Example 1-5

### Production of Granulated Matter d-ii-1

The granulated matter d-ii-1 was produced in the same manner as in Production example 1-1 except that the raw materials charged in the high-speed mixer were replaced with 70 parts by weight of tetraacetylethylenediamine, 5 parts by weight of POEO, 5 parts by weight of ES, 5 parts by weight of succinic acid and 15 parts by weight of PEG.

### Preparation of the Inorganic Peroxide

### Production Example 2

### Method of Preparing Coated Sodium Percarbonate PC-1

3% as compared with sodium percarbonate were coated with sodium metaborate ·4H₂O according to Example 1 in JP-A 59-196399.

### Production of the Detergent Base Material

### Production Example 3

An aqueous slurry containing 60% of solid content was prepared from 2 kg of sodium linear-alkylbenzenesulfonate, 0.5 kg of sodium laurylsulfate, 0.3 kg of polyoxyethylenealkyl ether (added with 10 moles on the average to a primary C₁₂₋₁₃ branched alcohol EO), 0.3 kg of acrylic acid-maleic acid copolymer (with the molar ratio of 80:20, the weight average molecular weight of 40,000), 0.3 kg of a fatty acid salt (of a beef tallow, Na salt), 0.6 kg of sodium carbonate, 1.5 kg of No. 1 sodium silicate, 1.5 kg of zeolite A (having the average particle diameter of 0.3 μm and pore size of 4 Å), 0.4 kg of Glauber's salt and 0.1 kg of PEG. The granules obtained by spraying-drying the slurry were charged in a high-speed mixer (FS-GC-10) supplied by Fukae Kogyo K. K. and granulated to obtain a detergent base material (having the average granular diameter of 400 μm, the bulk-density of 750 g/L).

### EXAMPLE 1

The bleaching detergent compositions of Table 1 were prepared by using the bleaching activator granules, the coated sodium percarbonate and the detergent base material prepared by the above-mentioned methods. The bleaching detergent effects of these compositions were evaluated according to the method described below. The results are shown in Table 1.

### Evaluation of the Bleaching Effect

### Evaluation Method 1

10 g of each of compositions shown in Table 1 was dissolved in 2 L of tap water. 5 sheets of curry-stained cloth or 5 sheets of tea-stained cloth prepared as described below were soaked in the solution thereof for 60 minutes. Thereafter, the sheets were rinsed by tap water and dried. The bleaching rate was calculated according to the following formula.

### Evaluation Method 2

An aqueous solution having 0.133% by weight (used with tap water) of each of compositions shown in Table 1 was used to wash 5 sheets of curry-stained cloth or 5 sheets of tea-stained cloth prepared as described below with a washing test device of Terg-O-Tometer (in the amount of the aqueous solution of 1 L, at the temperature of water being 20° C., at the rotation rate of 100 rpm, for 10 minutes to wash). Thereafter, the sheets were rinsed by tap water and dried. The bleaching rate was calculated according to the following formula.

$$\begin{matrix}The \\ \begin{matrix}bleaching \\ rate ( \% )\end{matrix}\end{matrix} = \frac{\begin{matrix}Reflectance after bleaching - \\ Reflectance before bleaching\end{matrix}}{\begin{matrix}Reflectance of white \text{(} no \text{-} stained \text{)} cloth - \\ Reflectance before bleaching\end{matrix}} \times 100$$

The reflectance was measured by using NDR-101 DP supplied from Nippon Denshoku Kogyo with a 460 nm filter.

### Preparation of the Stained Cloth

### Preparation of the Tea-Stained Cloth

80 g of tea leaves of Nittoh black Tea (yellow-packaged) was boiled for approximately 15 minutes in 3 L of deionized water. Then, the solution was filtered with a sheet of cotton cloth de-starched and washing-softened. Cotton shirting cloth #2003 was soaked in the filtered solution and boiled for approximately 15 minutes. They were removed from the heat source and left for about 2 hours. The cotton cloth was then taken out from the solution, naturally dried, and washed with water until a washing liquid therefor did not get colored. Thereafter, the cotton cloth was dewatered, pressed and served to experiments as testing pieces having areas of 10 cm×10 cm.

### Preparation of Curry-Stained Cloth

The solid content of a retort curry product supplied by House Food Co., Ltd. (as trade name of Curry Marche) was removed by a mesh. Then, the obtained liquid was heated until it boiled. Cotton shirting cloth #2003 was soaked in the liquid and boiled for approximately 15 minutes in the liquid. They were removed from the heat source and left for about 2 hours. The cotton cloth was then taken out of the liquid, and the excess curry liquid attached to the cotton cloth was removed by a spatula. After being dried naturally, the cotton cloth was pressed and served to experiments as testing pieces having areas of 10 cm×10 cm.

TABLE 1

| Inventive product | | | | Comparative product | | | | |
|---|---|---|---|---|---|---|---|---|
| 1 | 2 | 3 | 4 | 1 | 2 | 3 | 4 | 5 |

Bleaching detergent composition
Component to be blended (% by weight)

| | | | | | | | | | | |
|---|---|---|---|---|---|---|---|---|---|---|
| Granulated | a-1 | 2.5 | | | 4 | 5 | | | | |
| matter | a-2 | | 2.5 | | | | | | | |
| | d-i-1 | 2.5 | 2.5 | | 1 | | 5 | | | |
| | ab-1 | | | 5 | | | | | | |
| TAED⁽¹⁾ | | | | | | | | | 5 | 5 |
| PC-1 | | 5 | | | 5 | 5 | 5 | 5 | 5 | 5 |
| Sodium | | | 84.0 | 84.0 | | | | | | |
| percarbonate⁽²⁾ | | | | | | | | | | |
| Detergent base | | 85.9 | | | 85.9 | 85.9 | 85.9 | 85.9 | 85.9 | 85.9 |
| material | | | | | | | | | | |
| Sodium | | | 9.5 | 9.5 | | | | 5 | | |
| carbonate⁽³⁾ | | | | | | | | | | |
| Cellulase⁽⁴⁾ | | 0.5 | | | 0.5 | 0.5 | 0.5 | 0.5 | 0.5 | 0.5 |
| Protease⁽⁵⁾ | | 0.5 | 0.5 | 0.5 | 0.5 | 0.5 | 0.5 | 0.5 | 0.5 | 0.5 |
| Fluorescent | | 0.1 | | | 0.1 | 0.1 | 0.1 | 0.1 | 0.1 | 0.1 |
| whitening | | | | | | | | | | |
| agent⁽⁶⁾ | | | | | | | | | | |
| Crystalline | | 3.0 | 1.0 | 1.0 | 3.0 | 3.0 | 3.0 | 3.0 | 3.0 | 3.0 |
| silicate⁽⁷⁾ | | | | | | | | | | |
| Total sum | | 100 | 100 | 100 | 100 | 100 | 100 | 100 | 100 | 100 |
| Molar ratio of | | 2.8 | 1.6 | 2.8 | 8.9 | — | — | — | — | — |
| (a)/(b) | | | | | | | | | | |
| Washing method | | Method 2 | Method 1 | Method 1 | Method 2 | Method 2 | Method 2 | Method 2 | Method 2 | Method 2 |
| Bleaching | Tea- | 28 | 47 | 51 | 25 | 17 | 6 | 4 | 9 | 10 |
| rate (%) | stain | | | | | | | | | |
| | Curry- | 61 | 55 | 59 | 55 | 40 | 52 | 38 | 40 | 52 |
| | stain | | | | | | | | | |

Note:
⁽¹⁾Tetraacetylethylenediamine (supplied by Clariant)
⁽²⁾The average granular diameter of 400 μm (wherein granules having granular diameters of no larger than 125 μm and granules having granular diameters exceeding 1410 μm are

Note:

(1) : Tetraacetylethylenediamine (supplied by Clariant)

(2) : The average granular diameter of 400 μm (wherein granules having granular diameters of no larger than 125 μm and granules having granular diameters exceeding 1410 μm are eliminated, supplied by Nipon Peroxide, Co., Ltd.)

(3) : The average granular diameter of 250 μm

(4) : KAC 500 (supplied by Kao Corp.)

(5) : KAP 4.3 G (supplied by Kao Corp.)

(6) : PHOTINE CBUS-3B (supplied by Hickson & Welch Ltd.)

(7) : SKS-6 (supplied by Clariant)

### EXAMPLE 2

By using the components obtained by the above-mentioned Production examples and the following components, the bleaching detergent compositions of Table 2 were prepared.

The dye-transfer inhibiting effect and the bleaching detergent effect thereof were evaluated according to the method described below. The results are shown in Table 2.

D-1: No.2 sodium silicate

E-1: Sodium linear-alkyl (having 12 to 14 carbon atoms) benzenesulfonate

E-2: Sodium alkylsulfate [Emal 10 powder (supplied by Kao Corp.)]

E-3: Myristic acid

E-4: Polyoxyethylenelauryl ether [added with 10 moles of EO to Kalcohl 2098 (a C₁₂ alcohol supplied by Kao Corp.)]

F-1: Alkaline cellulase [KAC 500 (supplied by Kao Corp.)]

F-2: Alkaline protease [KAP 11.1 G (supplied by Kao Corp.)]

G-1: Acrylic acid-maleic acid copolymer [Sokalan CP-5 (supplied by BASF)]

H-1: Zeolite A (the average primary particle diameter of 0.3 μm)

I-1: Fluorescent whitening agent [PHOTINE CBUS-3B (supplied by Hickson & Welch Ltd.)]

### Evaluation of Dye-Transfer Inhibiting Effect

### Evaluation Method 3

An aqueous solution having 0.133% by weight (used with tap water) of each of compositions shown in Table 2 was used with a washing test device of Terg-O-Tometer to wash 5 sheets made of nylon cloth (10 cm×10 cm) dyed by Acid Red No. 151 together with 5 sheets of an un-dyed cotton shirting cloth #2003 (10 cm×10 cm). The temperature of the washing liquid was 20° C. or 80° C. (in the amount of the aqueous solution of 1 L, at the rotation rate of 100 rpm, for 10 minutes to wash). Thereafter, the sheets were rinsed by tap water and dried. The un-dyed cotton shirting cloth #2003 was evaluated according to the criteria described below. In Table, ◯ represents the average point of less than 0.8, □ represents the average point of from not less that 0.8 to less than 1.5, Δ represents that the average point of from not less than 1.5 to less than 2, x represents the average point of not less than 2.

0: Dye-transfer is not observed at all.

1: Slight dye-transfer is observed but not minded.

2: Dye-transfer is observed.

3: Remarkable dye-transfer is observed.

4: Serious dye-transfer is observed.

### Evaluation of Bleaching Effect

### Evaluation Method 4

The aqueous solution having 0.133% by weight (used with tap water) of each of compositions shown in Table 2 was used to respectively wash every 5 sheets of tea-stained cloth prepared as described below with a washing test device of Terg-O-Tometer (in the amount of the aqueous solution of 1 L, at the temperature of water being 20° C. or 80° C., the rotation rate being 100 rpm, for 10 minutes to wash). Thereafter, the sheets were rinsed by tap water and dried. The bleaching rate was calculated according to the following formula.

$$\begin{matrix}The \\ \begin{matrix}bleaching \\ rate ( \% )\end{matrix}\end{matrix} = \frac{\begin{matrix}Reflectance after bleaching - \\ Reflectance before bleaching\end{matrix}}{\begin{matrix}Reflectance of white \text{(} no \text{-} stained \text{)} cloth - \\ Reflectance before bleaching\end{matrix}} \times 100$$

The reflectance was measured by using NDR-101 DP supplied by Nippon Denshoku Kogyo with a 460 nm filter.

### Preparation of Stained Cloth

### Preparation of Tea-Stained Cloth

The tea-stained cloth was prepared in the same manner as in Example 1.

TABLE 2

| Inventive | | | Comparative | |
|---|---|---|---|---|
| product | | | product | |
| 5 | 6 | 7 | 6 | 7 |

Component to be blended (% by weight)

| | | | | | | |
|---|---|---|---|---|---|---|
| Granulated matter a-1 | | 2 | | 10 | 4 | |
| Granulated matter a-2 | | | 2 | | | |
| Granulated matter d-ii-1 | | 2 | 2 | 10 | | 4 |
| PC-1 | | 5 | 5 | 60 | 5 | 5 |
| D-1 | | 15 | 15 | 15 | 15 | 15 |
| E-1 | | 20 | 20 | 0.5 | 20 | 20 |
| E-2 | | 5 | 5 | | 5 | 5 |
| E-3 | | 2 | 2 | | 2 | 2 |
| E-4 | | 5 | 5 | 0.5 | 5 | 5 |
| F-1 | | 0.5 | 0.5 | 0.5 | 0.5 | 0.5 |
| F-2 | | 0.5 | 0.5 | 0.5 | 0.5 | 0.5 |
| G-1 | | 3 | 3 | 0.5 | 3 | 3 |
| H-1 | | 2 | 2 | 0.5 | 20 | 20 |
| I-1 | | 0.1 | 0.1 | | 0.1 | 0.1 |
| Sodium carbonate (dense ash) | | 15 | 15 | 20 | 15 | 15 |
| Sodium sulfate | | Balance | Balance | Balance | Balance | Balance |
| Total sum | | 100 | 100 | 100 | 100 | 100 |
| Dye-transfer | 20° C. | ∘ | ∘ | ∘ | □ | Δ |
| inhibiting | 80° C. | □ | □ | □ | Δ | Δ |
| effect | | | | | | |
| Bleaching | 20° C. | 39 | 39 | 44 | 33 | 28 |
| effect (%) | 80° C. | 48 | 46 | 53 | 41 | 35 |

1. A bleaching detergent composition comprising
(a) an alkannitrile derivative in which a quaternary ammonium group is bonded to the α-carbon atom of the derivative,
(b) an inorganic peroxide, and
(c) an alkali metal carbonate.

2. The bleaching detergent composition as claimed in claim 1, further comprising an alkanoyloxybenzenesulfonic acid having the alkanoyl group of 6 to 14 carbon atoms or an alkanoyloxybenzenecarboxylic acid having the alkanoyl group of 6 to 14 carbon atoms or a salt thereof.

3. The bleaching detergent composition as claimed in claim 1, further comprising tetraacetylethylenediamine.

4. The bleaching detergent composition as claimed in claim 1, wherein the component (a) is a compound represented by the following formula (1) or (2): 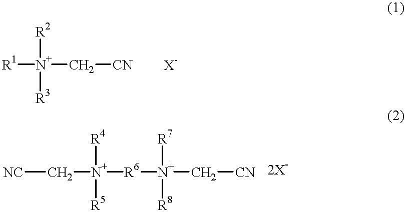
wherein R¹ represents an alkyl group having 1 to 6 carbon atoms, which may be interrupted by an ester group, an amide group or an ether group; R⁶ represents an alkylene group having 1 to 8 carbon atoms, which may be interrupted by an ester group, an amide group or an ether group and which may be substituted by a hydroxy group; each of R², R³, R⁴, R⁵, R⁷ and R⁸ independently represents an alkyl or hydroxyalkyl group having 1 to 3 carbon atoms; and X⁻ represents an anionic ion.
